(19) United States
(12) Patent Application Publication
(10) Pub. No.: US 2013/0167223 A1
(43) Pub. Date: Jun. 27, 2013

(54) METHODS AND APPARATUS FOR SECURING A SOFTWARE APPLICATION ON A MOBILE DEVICE

(71) Applicants: Jain Prerna, New Delhi (IN); Chandrika Krishnamurthy, Bangalore (IN)

(72) Inventors: Jain Prerna, New Delhi (IN); Chandrika Krishnamurthy, Bangalore (IN)

(73) Assignee: Symbol Technologies, Inc., Schaumburg, IL (US)

(21) Appl. No.: 13/355,688

(22) Filed: Jan. 23, 2012

(30) Foreign Application Priority Data
Dec. 27, 2011 (IN) 3838/DEL/2011

(51) Int. Cl. G06F 12/14; H04W 12/06

(52) U.S. Cl. 726/18

(57) ABSTRACT

A method of securing a software application on a mobile device is described. The method includes configuring the mobile device with a management server to allow the mobile device to communicate wirelessly over a wireless network. A listing of applications is transmitted to the management server over the wireless network. The management server generates user credentials data to associate at least one user with an authorization to access at least one application residing on the mobile device. The management server transmits the user credentials data to the mobile device over the wireless network. The mobile device accesses the user credentials data when a user attempts to access the software application on the mobile device. The user is permitted to execute the software application when the user credentials data indicates that the user is authorized to access the software application.

### TECHNICAL FIELD

The present invention generally relates to mobile units such as mobile computing devices, cellular phones, personal data assistants (PDAs), and the like, and more particularly relates to providing access to software applications on such devices.

### BACKGROUND

In recent years the use of cellular phones, smart phones, global positioning systems (GPS), personal data assistants (PDAs), laptop computers, and other such mobile units has increased dramatically. In any given enterprise, it is not uncommon for many thousands of mobile units to be present within the system. It is therefore a difficult but critical task to administer large groups of mobile units, particularly when their use is important to day-to-day operation of the enterprise.

One administrative task relates to providing access to software applications residing on the mobile devices. Presently known security schemes require that a user input a password at a startup screen on the display of the mobile device to gain access to the device functionality and the software applications residing on the device.

### SUMMARY

In one aspect, the invention is embodied in a method of securing a software application on a mobile device. The method includes configuring the mobile device with a management server to allow the mobile device to communicate wirelessly over a wireless network. A listing of applications including the software application residing on the mobile device is transmitted to the management server over the wireless network. User credentials data are generated to associate at least one user with an authorization to access at least one application residing on the mobile device. The user credentials data is transmitted to the mobile device from the management server over the wireless network. The mobile device accesses the user credentials data when a user attempts to access the software application on the mobile device. The user is permitted to execute the software application when the user credentials data indicates that the user is authorized to access the software application.

In one embodiment, the management server stages the mobile device for communication over the wireless network. The user credentials data can be encrypted prior to transmitting the user credentials data to the mobile device over the wireless network.

In one embodiment, the user is prompted to enter a password when the user attempts to access the software application on the mobile device. Access to the software application can be blocked in the event that the user enters a predetermined number of incorrect passwords. The user can be validated on the management server when the user attempts to execute the software application on the mobile device. The management server can be notified when the user attempts to access the software application on the mobile device.

In one embodiment, the management server can be notified when the user credentials data indicates that the user is not authorized to access the software application. Access to the software application can be blocked when the user credentials data indicates that the user is not authorized to access the software application. Access to the software application can be granted for a predetermined time period and access to the software application can be denied upon expiration of the predetermined time period.

In another aspect, the invention is embodied in a system for securing a software application. The system includes a mobile device having a plurality of applications including the software application. A management server configures the mobile device to allow the mobile device to communicate wirelessly over a wireless network. The management server receives a listing of applications including the software application residing on the mobile device. The management server generates user credentials data to associate at least one user with an authorization to access at least one application in the listing. The management server transmits the user credentials data to the mobile device over the wireless network. The mobile device accesses the user credentials data when a user attempts to execute the software application on the mobile device. The user credentials data indicates whether the user is authorized to access the software application.

In one embodiment, the management server stages the mobile device for communication over the wireless network. The management server can encrypt the user credentials data prior to transmitting the user credentials data to the mobile device over the wireless network.

In one embodiment, the mobile device prompts the user to enter a password when the user attempts to access the software application on the mobile device. The mobile device and/or the management server can block access to the software application when the user enters a predetermined number of incorrect passwords. The mobile device can notify the management server when the user attempts to access the software application on the mobile device.

The mobile device can notify the management server when the user credentials data indicates that the user is not authorized to access the software application. The mobile device and/or the management server can block access to the software application when the user credentials data indicates that the user is not authorized to access the software application.

In one embodiment, the mobile device and/or the management server can permit the user to execute the software application for a predetermined time period and can block access to the software application upon expiration of the predetermined time period.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a block diagram of a system for securing access to a software application residing on a mobile unit in accordance with an exemplary embodiment of the present invention.

FIG. 2 is a block diagram of a mobile device in accordance with an exemplary embodiment of the present invention.

FIG. 3 illustrates a method of securing access to a software application residing on a mobile device in accordance with an exemplary embodiment of the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

For the purposes of conciseness, many conventional techniques and principles related to staging or provisioning mobile devices to communicate and be managed over a wireless network, need not, and are not, described in detail herein. For example, conventional techniques related to signal processing, data transmission, signaling, network control, the 802.11 family of specifications, wireless networks, cellular networks, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Before describing in detail embodiments that are in accordance with the present invention, some of the terms used herein will be defined.

As used herein, the term “authentication” (or variants thereof) refers to the act of establishing or confirming that something is authentic. An authentication process involves the interchange of information between a wireless mobile device and another entity so that each can prove its identity to the other.

As used herein, the term “encryption” (or variants thereof) refers to the process of encoding or transforming information (sometimes referred to as plaintext) via an algorithm (sometimes called cipher) to generate encrypted information (sometimes referred to as ciphertext) that is unreadable to anyone except for intended recipients possessing special knowledge (e.g., an encryption key). Encryption is used to prevent unauthorized access to the data that is encrypted and protect data when being transferred over a network.

As used herein, the word “exemplary” means “serving as an example, instance, or illustration.”

As used herein, the term “decryption” (or variants thereof) refers to the process of making encrypted information readable again (i.e., restoring encrypted information to its original form).

As used herein, the term “key” refers to a piece of information used to transform plaintext into ciphertext, or vice versa. An encryption key is a sequence of data that is used to encrypt other data (i.e., generate encrypted data). The same key is required to decrypt the encrypted data.

As used herein, the term “staging” (or variants thereof) refers to preparing a wireless mobile device for initial use in enterprise infrastructure. In this regard, staging refers to configuring a wireless mobile device with network settings needed to allow it to connect to a server in the enterprise network, and then download and install software needed for making the device ready to be used in an enterprise environment. In some implementations, staging includes configuring network and device settings on a wireless mobile device as well as loading software (e.g., operating systems and applications) on the wireless mobile device. During staging, automated template-based configurations can be issued to a device and used to stage that device.

As used herein, the term “staging data” refers to initial data required by a wireless mobile device to address and connect to a server on the enterprise network and obtain a list of software (e.g., operating systems and applications) to be requested from that server. Staging data can include settings for the wireless mobile device and/or a list of software packages to be installed on the wireless mobile device and their respective server locations.

In one embodiment, the invention is embodied in a method for securing a software application on a mobile device. The method includes configuring the mobile device with a management server to allow the mobile device to communicate wirelessly over a wireless network.

The mobile device transmits a listing of applications including the software application that a user wishes to access that are residing on the mobile device to the management server over the wireless network. The management server can generate user credentials data to associate at least one user with an authorization to access one or more applications residing on the mobile device.

The management server transmits the user credentials data to the mobile device over the wireless network. The mobile device accesses the user credentials data when a user attempts to access the software application on the mobile device. The user is permitted to execute the software application when the user credentials data indicates that the user is authorized to access the software application.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems and methods of controlling access to software applications residing on mobile devices.

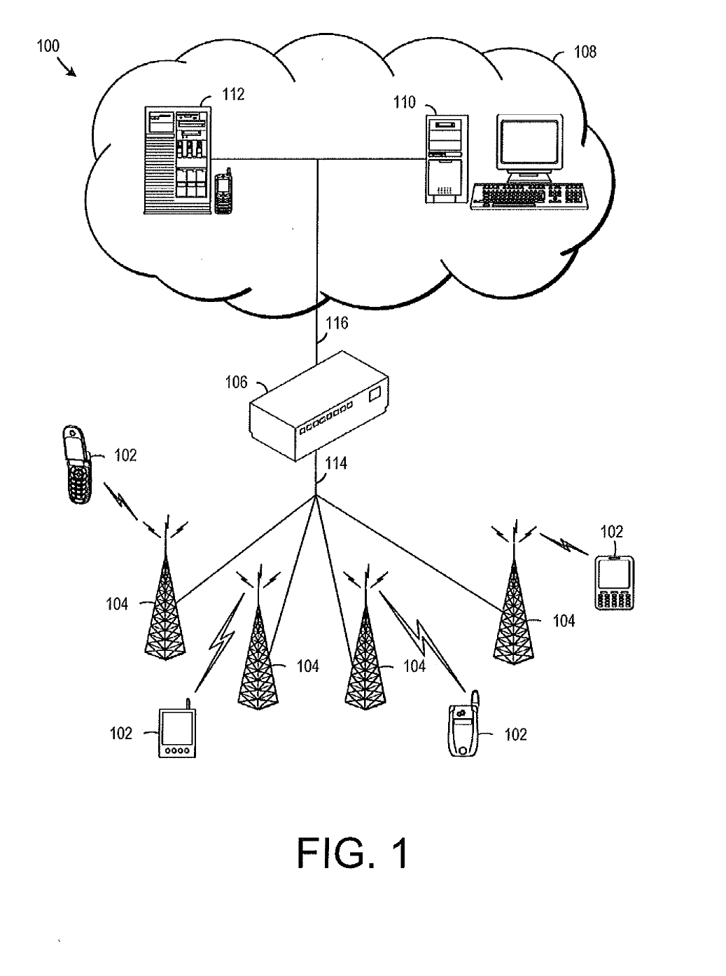

FIG. 1 is a block diagram of an exemplary system 100 which can be used in accordance with the disclosed embodiments. The system comprises a plurality of wireless mobile devices (WMDs) 102, wireless communication stations (WCSs) 104, a wide area network (WAN) gateway 106, an enterprise IP network 108 that includes a computer 110 that can be located at a Network Operations Center (NOC) and a Mobility Management Server (MMS) 112 that can also be located at NOC or remotely relative to the NOC. Although not shown, the enterprise IP network 108 can include a “destination” such as an IVRS, a voicemail server, etc.

Each of the WMDs 102 can communicate with at least one of the WCSs 104 over a wireless communication link. The WCSs 104 are coupled to the WAN gateway 106 via a wired connection 114, and the WAN gateway 106 is coupled to the enterprise IP network 108 via another wired connection 116. The WCSs 104 can be, for example, a base station (BS) when part of a cellular communications network, or an access point (AP) when part of a Wireless Local Area Network (WLAN).

As used herein, the term “wireless mobile device” refers to any portable computer or other hardware designed to communicate with an infrastructure device over an air interface through a wireless channel. In many cases a wireless communication device is “handheld” and potentially mobile or “nomadic” meaning that the wireless mobile device 102 can physically move around, but at any given time may be mobile or stationary. The wireless mobile device 102 can be one of any of a number of types of mobile computing devices, which include without limitation, mobile stations (e.g. mobile telephone handsets (sometimes also referred to as a mobile station (MS), mobile unit (MU), subscriber station, or user equipment (UE))), mobile radios, mobile computers, hand-held or laptop devices and personal computers, a PC card, personal digital assistants (PDAs), or the like), access terminals, compact flash, external or internal modem, an RFID reader, or the like, or any other devices configured to communicate via wireless communications.

The wireless mobile device 102 can communicate in accordance with any known wireless communication standards including telecommunication standards such as 3′″ Generation Partnership Project (3GPP), 3′″ Generation Partnership Project 2 (3GPP2), Global System for Mobile communication (GSM), Code Division Multiple Access (CDMA), Wide-band CDMA (WCDMA), Universal Mobile Telecommunications System (UMTS), Long Term Evolution (LTE) and the like) and those based on ad hoc networking standards (e.g., IEEE 802.91, IEEE 802.16, Worldwide Interoperability for Microwave Access (WiMax), and the like). The wireless mobile device 102 is designed to operate within a Wireless Wide Area Network (WWAN) over a cellular air interface (e.g., GSM, CDMA, WCDMA, UMTS, and the like) and/or an ad hoc networking air interface (e.g., IEEE 802.11 WLAN interfaces, IEEE 802.16 interfaces, WiMax interfaces, and the like). The wireless mobile devices 102 may be configured to communicate via WLAN protocols (IEEE 802.11 protocols), IrDA (infrared), Bluetooth, ZigBee (and other variants of the IEEE 802.15 protocol), IEEE 802.16 (WiMAX or any other variation). As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA. Any of the IEEE standards or specifications referred to herein are incorporated herein by reference in their entirety.

When the wireless mobile device (WMD) 102 operates in a wireless cellular network (i.e., uses mobile telecommunication cellular network technologies to transfer data), it communicates with a fixed base station (BS) that is coupled to a wired core network, and when it operates in a WLAN, the WMD 102 can communicate with an access point or access port that is could to a wired network. As used herein, the term “uplink (UL) or reverse link (RL)” refers to a communication link for carrying information from a station to a base station (or alternatively an access point), and can also refer to a transmission from a station to a base station. As used herein, the term “downlink (DL) or forward link (FL)” refers a communication link that carries information from a base station (or alternatively an access point) to a station and can also refer to a transmission from a base station to a station. In the embodiments described herein, the UL and DL are implemented using multiple access methods including any one of FDMA, TDMA, CDMA, WCDMA, and OFDMA.

Each of the WMDs 102 can communicate directly with a WCS 104 over wireless communication links, which are illustrated in FIG. 1 using lightning bolts. A WMD 102 is potentially mobile (i.e., not fixed) and can be mobile at any particular time, whereas the WCS 104 is typically fixed at a particular location.

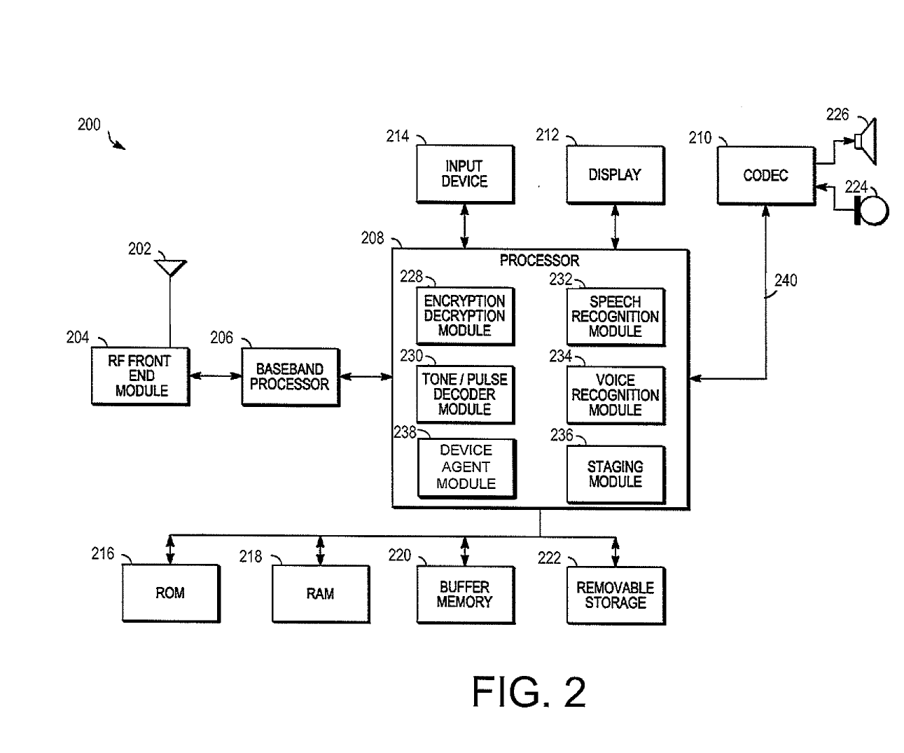

As described in more detail herein with reference to FIG. 2, each WMD 102 includes at least one antenna, a transceiver, at least one port, a controller and memory. The transceiver is used to transmit and receive both data and control/signaling/management information transmitted from the WCS 104 via the antenna(s). The port is used for communications with WCS 104 and is coupled to the controller for operation of the WMD 102. Each of the ports employs conventional demodulation and modulation techniques for receiving and transmitting communication signals to and from the WMD 102, respectively, under the control of the controller.

To perform the necessary functions of the WMD 102, the controller is coupled to the memory, which preferably includes a random access memory, a read-only memory (ROM), an electrically erasable programmable read-only memory (EEPROM), and flash memory. The memory can be integrated within the WMD 102, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes an interface for communicating with the WMD 102.

The WCS 104 can communicate data and/or control signaling information with the WMDs 102, where an uplink can carry data and/or control information transmitted from a WMD 102 to the WCS 104 and a downlink can carry data information and/or control or signaling information transmitted from the WCS 104 to a WMD 102. In some implementations, WMDs 102 can communicate information directly with each other over peer-to-peer communication links (not illustrated) that carry information from one WMD 102 to another.

The WCS 104 comprises antennas, a transceiver, circuitry for analog-to-digital conversion and vice-versa, a plurality of ports, a controller that includes a resource scheduler module that schedules uplink resources for communications with various WMDs 102, and a memory.

Each port provides an endpoint or channel for network communications by the WCS 104. Each port can be used to transmit and receive data and control, signaling or management information. A backhaul port can provide an endpoint or channel for backhaul communications by the WCS 104 with the core network 108. For example, the WCS 104 can communicate with a wired backhaul via the backhaul port. Each of the ports is coupled to the controller for operation of the WCS 104. Each of the ports employs conventional demodulation and modulation techniques for receiving and transmitting communication signals respectively, such as packetized signals, to and from the WCS 104 under the control of the controller. The packetized signals can include, for example, voice, data or multimedia information, and control information.

As used herein, the term “data” can refer to, for example, data generated by applications, a network management entity, or any other higher-layer protocol entities. Examples of user data include, for example, packets generated by voice, video, e-mail, file transfer applications and network management agents.

As used herein, the term “control information” can refer to, for example, messages and signaling used by the media access control (MAC) layer and physical (PHY) layer to carry out its own protocol functionality. Control information includes periodic control information and aperiodic control information.

As used herein, the term “periodic control information” can refer to, for example, preambles, midambles, synchronization sequences, timing and frequency correction channels or any other signaling used to ensure correct reception of the messages transmitted in a frame. Examples of periodic control information include, for example, frame control information, a synchronization channel, preamble information, information regarding the frame structure, markers which flag the start of the frame, and other types of control information.

As used herein, the term “aperiodic control information” can refer to, for example, messages transmitted aperiodically to ensure proper protocol behavior and WMD upkeep. Examples of aperiodic control information include, for example, management and control information, such as capability announcements, ranging messages, measurement reports, and handoff instructions.

To perform the necessary functions of the WCS 104, the controller is coupled to the memory, which preferably includes a random access memory, a read-only memory (ROM), an electrically erasable programmable read-only memory (EEPROM), and flash memory. The memory can be integrated within the WCS 104 or alternatively, can be at least partially contained within an external memory such as a memory storage device.

The MMS 112 is configured to communicate with a plurality of wireless mobile devices 102 (e.g., wirelessly or through a wired connection or using one or more intermediate switches, routers, relay servers, access points, or the like). The MMS 112 can include any combination of hardware and software capable of carrying out the functions described herein. In that regard, the MMS 112 may also include various networking components, databases, consoles, etc., which, for the sake of clarity, are not illustrated in the figures. In one embodiment, for example, the MMS 112 corresponds to one of the various Mobility Service Platform (MSP) servers provided by Motorola Solutions, Inc. In one implementation, the MMS 112 resides at a Network Operations Center (NOC) and communicates with mobile devices 102 via one or more Relay Servers (not illustrated) which are used to relay information to and from mobile devices 102 being managed by a management server.

Although not illustrated in FIG. 1, the MMS 112 includes a module that communicates with a device agent module (not illustrated) on each of the mobile devices 102. The MMS 112 makes high level decisions, deploys executable code and data to the device agent modules as needed, collects results, generates reports of the results, and determines future action that are required. The device agent module analyzes actual real-time conditions on the device, based on previously deployed information from the control server, performs local remediation and logging, and sends periodic updates to the control server for tracking, forensic, and future planning purposes.

The MMS 112 can receive listing of software applications residing on each of the mobile devices 102. In one embodiment, the MMS 112 stores the listing in a database residing in a memory of the MMS 112. The database can also include a record of each user registered in the system as well as user credential data. The user credential data associates each registered user with an authorization to access one or more applications in the listing of software applications residing on each mobile device 102.

The MMS 112 transmits the user credentials data over the wireless network to each of the mobile devices 102 that are managed by the MMS 112. The user credentials data can be stored in a memory of the mobile device 102. A device agent module of the MMS 112 resides on each mobile device 102 managed by the MMS 112. The device agent module can control user access to the software applications residing on each specific mobile device 102.

When a user attempts to execute a software application on the mobile device 102, the device agent module residing on the mobile device 102 accesses the user credentials data. The user credentials data indicates whether or not the user is authorized to access the software application. In one embodiment, the mobile device 102 prompts the user to enter a password when the user attempts to access the software application on the mobile device 102. In another embodiment, the user credentials data indicates that the user is permitted to access certain applications residing on the mobile device 102. For example, when a user logs into the mobile device 102, only applications associated with that user are accessible. User access is denied if the user attempts to locate and access non-permitted applications.

In one embodiment, the mobile device 102 notifies the MMS 112 when the user attempts to access a software application on the mobile device 102 regardless of whether the user is permitted to access it or not permitted to access it. In another embodiment, the mobile device 102 notifies the MMS 112 only when the user attempts to access a restricted software application on the mobile device 102.

In one embodiment, the mobile device 102 and/or the MMS 112 can block access to the software application and/or other functions of the mobile device 102 when the user enters a predetermined number of incorrect passwords or when the user's biometric information is not verified.

In one embodiment, the MMS 112 encrypts the user credentials data prior to transmitting the user credentials data to each mobile device 102 over the wireless network. The device agent module residing on the mobile device 102 is capable of decrypting the encrypted user credentials data.

In one embodiment, the mobile device 102 notifies the MMS 112 when the user credentials data indicates that the user is not authorized to access a certain software application residing on the mobile device 102. A user of the mobile device 102 can send a request to the MMS 112 to gain access to a specific application residing on the mobile device. In response to an acceptance of the request, the MMS 112 can modify the user credentials data and transmit the modified user credentials data to the mobile device 102. Alternatively, the MMS 112 can transmit a message indicating a reason for denying the request.

In one embodiment, when a user attempts to access a software application on the mobile device 102, the mobile device 102 contacts the MMS 112 to request permission. The MMS 112 accesses the user credentials data and either grants or denies permission based on the user credentials data. For example, the MMS 112 blocks access to the software application when the user credentials data indicates that the user is not authorized to access the software application.

In one embodiment, the user credentials data can indicate that a user is permitted to access the software application for a certain period of time. For example, a user may only require access to a certain software application during her shift. In that case, access to the software application can be granted during the shift and denied once the shift is completed.

FIG. 2 is a block diagram of a mobile device 200 in accordance with an exemplary embodiment of the present invention. The wireless mobile device 200 includes at least one antenna 202, an RF front end module 204, a baseband processor 206, a processor 208, a coder/decoder (CODEC) 210, a display 212, input devices 214 (keyboards, touch screens, etc.), a program memory 216, 218 for storing operating instructions that are executed by the processor 208, a buffer memory 220, a removable storage unit 222, a microphone 224 and an earpiece speaker 226 (i.e., a speaker used for listening by a user of the device 200). The various blocks are coupled to one another as illustrated in FIG. 2. In some implementations, the various blocks can communicate with one another via a bus, such as a PCI bus. The mobile device 200 can also include a power source, such as a battery (not shown). The mobile device 200 can be an integrated unit containing at least all the elements depicted in FIG. 2, as well as any other elements necessary for the mobile device 200 to perform its particular functions. As will be appreciated by those skilled in the art, various other elements, components and modules can be included depending on the implementation.

The processor 208 controls an overall operation of the wireless mobile device 200. The processor 208 can include one or more microprocessors, microcontrollers, DSPs (digital signal processors), state machines, logic circuitry, or any other device or devices that process information based on operational or programming instructions. Such operational or programming instructions can be, for example, stored in the program memory that may be an IC (integrated circuit) memory chip containing any form of RAM (random access memory) or ROM (read-only memory), a floppy disk, a CD-ROM (compact disk read-only memory), a hard disk drive, a DVD (digital video disc), a flash memory card or any other medium for storing digital information. In one implementation, the Read Only Memory (ROM) 216 stores microcodes of a program for controlling the processor 208 and a variety of reference data, and the Random Access Memory (RAM) 218 is a working memory of the processor 208 and temporarily stores data that is generated during the execution of the program. The buffer memory 220 may be any form of volatile memory, such as RAM, and is used for temporarily storing received information packets. The removable storage 222 stores a variety of updateable data, and can be implemented using Flash RAM.

One of ordinary skill in the art will recognize that when the processor 208 has one or more of its functions performed by a state machine or logic circuitry, the memory 216, 218 containing the corresponding operational instructions may be embedded within the state machine or logic circuitry. Elements such as an encryption/decryption module 228, a tone/pulse decoder module 230, a speech recognition module 232, voice recognition module 234, MSP staging module 236 responsible for applying device settings and requesting/installing software from the MMS 112 (FIG. 1), the MSP device module 238 for controlling access to the software applications, etc. can be implemented at the processor 208 and/or memory 216, 218.

In operation, a MMS 112 manages the MSP device module 238 residing in the mobile device 200 that includes the plurality of applications including a software application requiring authorization to access.

The MMS 112 receives a listing of applications from the MSP device module 238 including the software application residing on the mobile device 200. The MMS 112 generates user credentials data to associate each registered user with an authorization to access at least one software application in the listing. The MMS 112 transmits the user credentials data to the mobile device 200 over the wireless network 108. The MMS 112 can encrypt the user credentials data prior to transmitting the user credentials data to the mobile device 200 over the wireless network 108.

The MSP device module 238 residing on the mobile device 200 accesses the user credentials data when a user attempts to execute the software application on the mobile device 200. The user credentials data indicates whether the user is authorized to access the software application. The MSP device module 238 can prompt the user to enter a password or a biometric when the user attempts to access the software application on the mobile device 200.

The MSP device module 238 and/or the MMS 112 can block access to the software application when the user enters a predetermined number of incorrect passwords. The MSP device module 238 can notify the MMS 112 when the user attempts to access the software application on the mobile device 200 or when the user credentials data indicates that the user is not authorized to access the software application.

The coder-decoder (CODEC) 210 communicates with the processor 208 over a bus 240. The speaker 226 and the microphone 224 connected to the CODEC 210 serve as an audio input/output block for communication. The CODEC 210 converts digital data from the processor 208 into analog audio signals and outputs the analog audio signals through the speaker 226. Also, the CODEC 210 converts audio signals received through the microphone 224 into digital data and provides the digital data to the processor 208.

Working together, the RF front end module 204 and baseband processor 206 enable the mobile device 200 to communicate information packets over the air and acquire information packets that are processed at the processor 208. In this regard, the RF front end module 204 and baseband processor 206 include conventional circuitry to enable transmissions over a wireless communication channel. The implementations of the RF front end module 204 and baseband processor 206 depend on the implementation of the mobile device 200. In general, the baseband processor 206 processes the baseband signals that are transmitted/received between the RF front end module 204 and the processor 208. The RF front end module 204 down-converts the frequency of an RF signal received through the antenna 202 and provides the down-converted RF signal to the baseband processor 206.

The baseband processor 206 receives digital baseband data (originally generated at the CODEC 210) from the processor 208 and converts the baseband data into real (I) and imaginary (Q) data streams. Although not shown, RF front end module 204 can also include conventional transmitter circuitry including a modulator, an upconverter module and a power amplifier. The modulator (not shown) is designed to modulate information from the baseband processor 206 onto a carrier frequency. The frequency of the modulated carrier is upconverted by the upconverter module to an RF frequency to generate an RF signal. The RF signal is amplified by a power amplifier (not shown) to a sufficient power level for radiation into free space and transmitted via the antenna 202. Although not shown, the RF signal is provided from the power amplifier to the antenna 202 over a transmission path between the power amplifier and antenna 202.

The antenna 202 comprises any known or developed structure for radiating and receiving electromagnetic energy in the frequency range containing the wireless carrier frequencies. The antenna 202 is coupled and matched to the electronic circuitry of the mobile device 200. As such, other elements (not shown) such as an antenna switch, duplexer, circulator, or other highly isolative means can also be present.

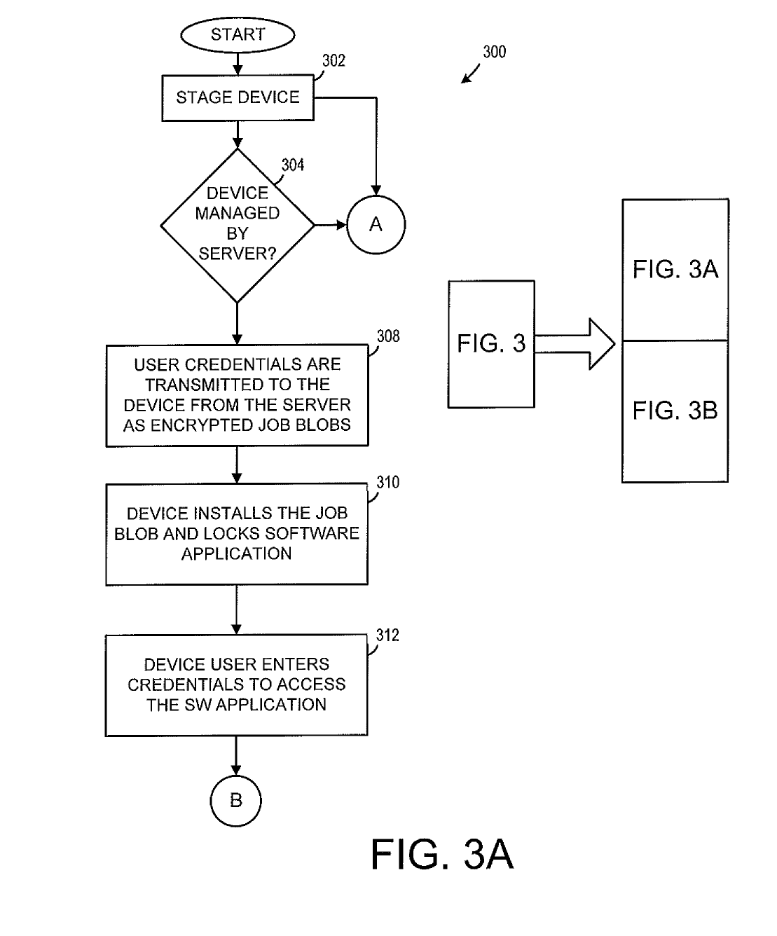

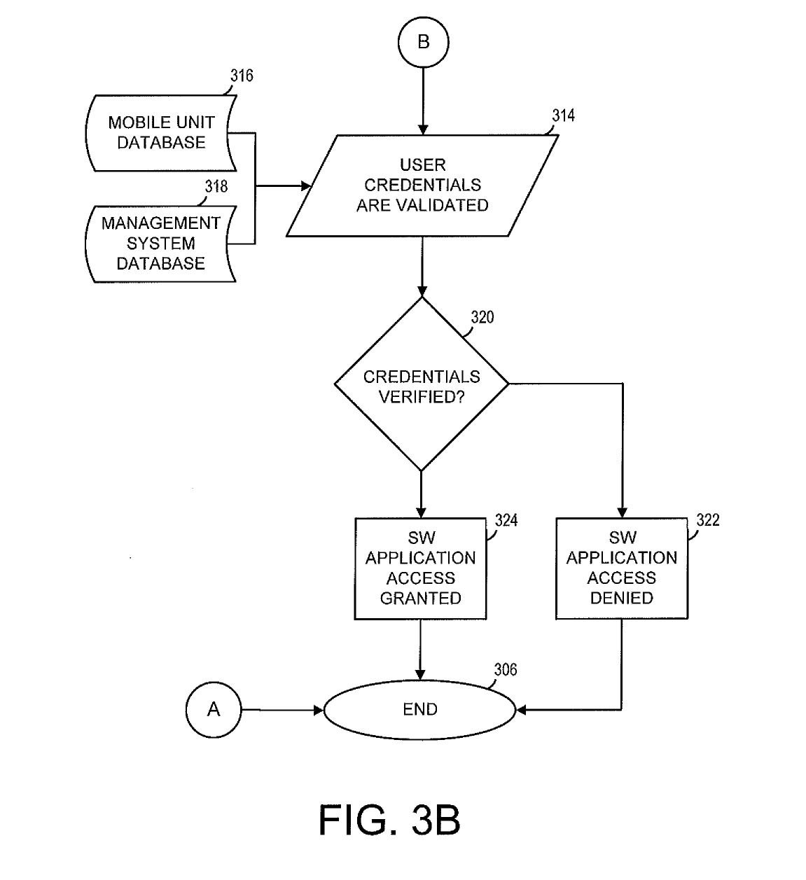

FIG. 3 illustrates a method 300 of securing access to a software application residing on a mobile device 200 (FIG. 2) in accordance with an exemplary embodiment of the present invention.

In step 302, a mobile device 102 is staged or configured by a management server 112 (FIG. 1) to provision it for communication over the wireless network 108. In one embodiment, the mobile device 102 is then managed by the management server 112 (step 304). If the mobile device 102 is not managed by the management server 112, the process ends (step 306).

The management server 112 can include a database storing user credential data that associates registered users with authorizations to access one or more specific applications on each managed mobile device 102. In one embodiment, each mobile device 102 under the management of the management server 112 transmits a listing of software applications residing on the specific mobile device 102 to the management server 112. The management server 112 is updated immediately or periodically as new software applications are installed on each specific mobile device 102.

In one embodiment, the management server 112 transmits the user credential data to each mobile device 102 as an encrypted job blob (step 308). Upon receipt of the encrypted job blob, the mobile device 102 decrypts the encrypted job blob and installs the job blob (step 310). The software applications requiring authorization to access are then secured by the mobile device 102. Software applications not requiring authorization to access are accessible to any user operating the mobile device 102.

A user enters user credentials to access a secured software application (step 312). For example, the user credentials can include a password or biometric information. In one embodiment, the user credentials can be entered when the user initially logs into the mobile device 102. For example, each user can have access to different software applications residing on the mobile device 102 depending on the user credentials data.

The user credentials are then validated (step 314). The user credentials can be validated locally on a database 316 stored on the mobile device 102. Alternatively, the user credentials can be validated remotely on a database 318 stored on the management server 112. In one embodiment, the user credentials are validated on both the database 316 stored on the mobile device 102 and the database 318 stored on the management server 112 in order to be granted access to the software application.

The user credentials are then verified (step 320). User access to the software application is denied in the event that the user credentials are not verified (step 322). User access to the software application is granted in the event that the user credentials are verified (step 324).

In the event that the user is denied access to a particular software application, the user can send a request to the management server 112 for permission to gain access to the particular software application. The management server 112 can decide to grant access to the user based on knowledge of the user, such as the user's position in the organization. The management server 112 can also send the request to an administrator who can decide whether or not to grant access to the user.

In one embodiment, the mobile device 102 and/or the management server 112 can block access to the secured software application when the user enters a predetermined number of incorrect passwords. The mobile device 102 can notify the management server 112 when a user attempts to access the software application on the mobile device 102. In one embodiment, the mobile device 102 notifies the management server 112 when the user credentials data indicates that the user is not authorized to access the software application.

In one embodiment, the mobile device 102 and/or the management server 112 permits the user to execute the software application for a predetermined time period and blocks access to the software application upon expiration of the predetermined time period.

Those skilled in the art will understand that the above described exemplary embodiments may be implemented in any number of manners, including, as a separate software module, as a combination of hardware and software, etc. For example, the staging applications of the mobile device and/or the staging server may be programs containing lines of code that, when compiled, may be executed on a processor.

In general, the processor can include processing logic configured to carry out the functions, techniques, and processing tasks associated with the operation of the mobile device 102. Furthermore, the steps of a method or algorithm described in connection with the embodiments disclosed herein may be embodied directly in hardware, in firmware, in a software module executed by the processor, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus described herein. The non-processor circuits may include, but are not limited to, a radio receiver, a radio transmitter, signal drivers, clock circuits, power source circuits, and user input devices. As such, these functions may be interpreted as steps of a method to perform the mobile device staging described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A method of securing a software application on a mobile device, the method comprising:
configuring the mobile device with a management server to allow the mobile device to communicate wirelessly over a wireless network;
transmitting a listing of applications including the software application residing on the mobile device to the management server over the wireless network;
generating user credentials data to associate at least one user with an authorization to access at least one application residing on the mobile device;
transmitting the user credentials data to the mobile device from the management server over the wireless network;
accessing the user credentials data when a user attempts to access the software application on the mobile device; and
permitting the user to execute the software application when the user credentials data indicates that the user is authorized to access the software application.

2. The method of claim 1 wherein the management server stages the mobile device for communication over the wireless network.

3. The method of claim 1 further comprising encrypting the user credentials data prior to transmitting the user credentials data to the mobile device over the wireless network.

4. The method of claim 1 further comprising prompting the user to enter a password when the user attempts to access the software application on the mobile device.

5. The method of claim 4 further comprising blocking access to the software application when the user enters a predetermined number of incorrect passwords.

6. The method of claim 1 further comprising validating the user on the management server when the user attempts to execute the software application on the mobile device.

7. The method of claim 1 further comprising notifying the management server when the user attempts to access the software application on the mobile device.

8. The method of claim 1 further comprising notifying the management server when the user credentials data indicates that the user is not authorized to access the software application.

9. The method of claim 1 further comprising blocking access to the software application when the user credentials data indicates that the user is not authorized to access the software application.

10. The method of claim 1 further comprising permitting the user to execute the software application for a predetermined time period and blocking access to the software application upon expiration of the predetermined time period.

11. A system for securing a software application, the system comprising:
a mobile device including a plurality of applications including the software application; and
a management server for configuring the mobile device to allow the mobile device to communicate wirelessly over a wireless network, the management server receiving a listing of applications including the software application residing on the mobile device and generating user credentials data to associate at least one user with an authorization to access at least one application in the listing, the management server transmitting the user credentials data to the mobile device over the wireless network,
wherein the mobile device accesses the user credentials data when a user attempts to execute the software application on the mobile device, the user credentials data indicating whether the user is authorized to access the software application.

12. The system of claim 11 wherein the management server stages the mobile device for communication over the wireless network.

13. The system of claim 11 wherein the management server encrypts the user credentials data prior to transmitting the user credentials data to the mobile device over the wireless network.

14. The system of claim 11 wherein the mobile device prompts the user to enter a password when the user attempts to access the software application on the mobile device.

15. The system of claim 14 wherein at least one of the mobile device and the management server blocks access to the software application when the user enters a predetermined number of incorrect passwords.

16. The system of claim 11 wherein the mobile device notifies the management server when the user attempts to access the software application on the mobile device.

17. The system of claim 11 wherein the mobile device notifies the management server when the user credentials data indicates that the user is not authorized to access the software application.

18. The system of claim 11 wherein at least one of the mobile device and the management server blocks access to the software application when the user credentials data indicates that the user is not authorized to access the software application.

19. The system of claim 11 wherein at least one of the mobile device and the management server permits the user to execute the software application for a predetermined time period and blocks access to the software application upon expiration of the predetermined time period.

20. A system for securing a software application, the system comprising:
means for configuring the mobile device with a management server to allow the mobile device to communicate wirelessly over a wireless network;
means for transmitting a listing of applications including the software application residing on the mobile device to the management server over the wireless network;
means for generating user credentials data to associate at least one user with an authorization to access at least one application residing on the mobile device;
means for transmitting the user credentials data to the mobile device from the management server over the wireless network;
means for accessing the user credentials data when a user attempts to access the software application on the mobile device; and
means for permitting the user to execute the software application when the user credentials data indicates that the user is authorized to access the software application.
